(19) United States
(12) Patent Application Publication
(10) Pub. No.: US 2023/0040239 A1
(43) Pub. Date: Feb. 9, 2023

(54) GATEWAY FOLDING FOR SIMPLIFYING THE VISUALIZATION OF PROCESS GRAPHS

(71) Applicant: UiPath, Inc., New York, NY (US)

(72) Inventor: Roeland Johannus SCHEEPENS, Eindhoven (NL)

(73) Assignee: UiPath, Inc., New York, NY (US)

(21) Appl. No.: 17/444,377

(22) Filed: Aug. 3, 2021

(51) Int. Cl. G06Q 30/04; G05B 19/4155; G06Q 10/10

(52) U.S. Cl. CPC G06Q 30/04; G05B 19/4155; G06Q 10/1053; G05B 2219/50391

(57) ABSTRACT

Systems and methods for visually representing a process graph are provided. A process graph representing execution of a process is received. One or more gateway nodes in the process graph are folded into their from-nodes based on a number of incoming edges and a number of outgoing edges of the one or more gateway nodes. The process graph according to the folded one or more gateway nodes is output.

### TECHNICAL FIELD

The present invention relates generally to process mining, and more particularly to gateway folding for simplifying the visualization of process graphs.

### BACKGROUND

Processes are sequences of activities executed by one or more computers to provide various services. The execution of a process may be represented as a process graph, where each activity is represented as a node and each execution between activities is represented as an edge linking nodes. At times, process graphs may comprise gateway nodes that do not add meaning but take up a lot of visual space. Conventionally, such process graphs are displayed to users with all gateway nodes, which may be visually confusing to the users.

### BRIEF SUMMARY OF THE INVENTION

In accordance with one or more embodiments, systems and methods for visually representing a process graph are provided. A process graph representing execution of a process is received. One or more gateway nodes in the process graph are folded into their from-nodes based on a number of incoming edges and a number of outgoing edges of the one or more gateway nodes. The process graph according to the folded one or more gateway nodes is output.

In one embodiment, it is determined that the one or more gateway nodes have a single incoming edge and a single outgoing edge. In response to determining that the one or more gateway nodes have a single incoming edge and a single outgoing edge, the one or more gateway nodes are folded into their from-nodes. In one embodiment, the one or more gateway nodes are folded into their from-nodes by traversing the process graph to identify a foldable gateway node having a single incoming edge and a single outgoing edge. A closest preceding non-foldable gateway node of the foldable gateway node and a next non-foldable gateway node of the foldable gateway node are identified, wherein the closest preceding non-foldable gateway node and the next non-foldable gateway node do not have a single incoming edge and a single outgoing edge. A plurality of edges between the closest preceding non-foldable gateway node and the next non-foldable gateway node is replaced with an edge between the closest preceding non-foldable gateway node and the next non-foldable gateway node.

In one embodiment, one or more paths of one or more parallel gateway nodes in the process graph that do not include an activity node are removed from the process graph. At least one of the one or more parallel gateway nodes is folded into its from-node in response to determining that the at least one parallel gateway node has a single path.

In one embodiment, all gateway nodes in an edge chart associated with the process graph are folded into their from-activity nodes.

In one embodiment, the process graph according to the folded one or more gateway nodes is displayed on a display device. The process may be an RPA (robotic process automation) process.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative process graph;

FIG. 2 shows another illustrative process graph;

FIG. 3 shows a method for visually representing a process model, in accordance with one or more embodiments;

FIG. 4 shows a visually simplified process graph of the process graph of FIG. 1, in accordance with one or more embodiments;

FIG. 5 shows a visually simplified process graph of the process graph of FIG. 2, in accordance with one or more embodiments;

FIG. 6 shows a process model with a corresponding edge chart without gateway folding;

FIG. 7 shows a process model with a corresponding edge chart with gateway folding, in accordance with one or more embodiments;

FIG. 8 shows a process model with a corresponding edge chart without gateway folding;

FIG. 9 shows a process model with a corresponding edge chart with gateway folding, in accordance with one or more embodiments; and

FIG. 10 is a block diagram of a computing system according to an embodiment of the invention.

### DETAILED DESCRIPTION

A process may be executed by one or more computers to provide services for a number of different applications, such as, e.g., administrative applications (e.g., onboarding a new employee), procure-to-pay applications (e.g., purchasing, invoice management, and facilitating payment), and information technology applications (e.g., ticketing systems). In one embodiment, the process may be an RPA (robotic process automation) process automatically executed by one or more RPA robots. The execution of a process may be recorded in the form of an event log. To facilitate user understanding of the execution of the process, a process graph of the process may be generated based on the event log and displayed to the user. The process graph is a visual representation of the execution of process.

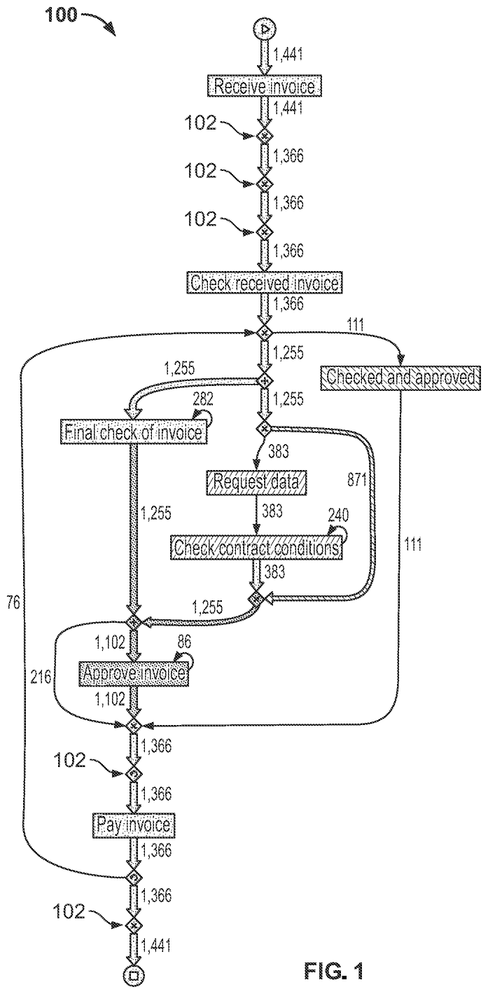

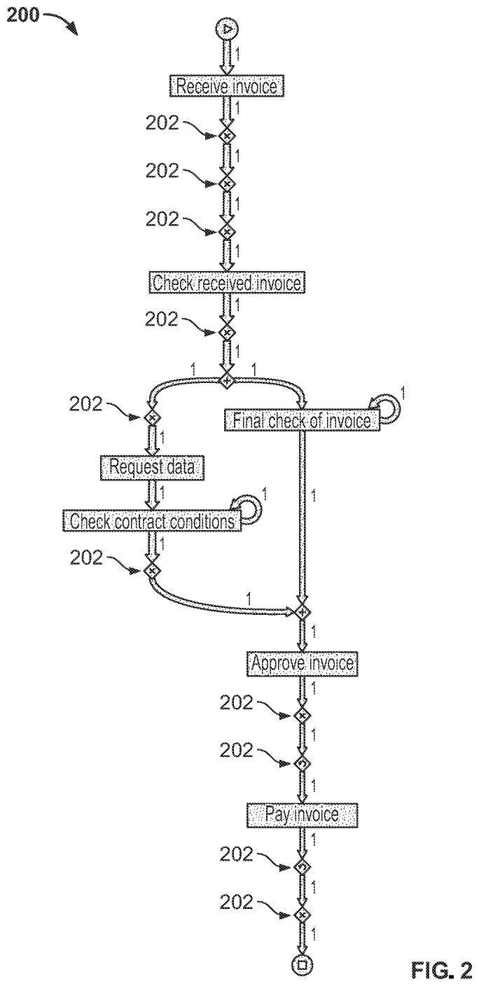

FIG. 1 shows an illustrative process graph 100. FIG. 2 shows another illustrative process graph 200. Process graph 100 of FIG. 1 and process graph 200 of FIG. 2 represent execution of a process for processing and paying an invoice. Process graphs 100 and 200 may be presented to a user to facilitate understanding of the execution of the process to thereby enable the user to perform various process mining tasks, such as, identifying bottlenecks in the process, conformance checking, etc.

Process graphs 100 and 200 are modelled as directed graphs where each activity of the process is represented as a node and the execution of the process from a source activity to a destination activity is represented as an edge connecting the nodes representing the source activity and the destination activity. Each edge in process graphs 100 and 200 is associated with a number representing a frequency of execution of that edge.

Process graphs 100 and 200 comprise various gateway nodes, which are shown as diamond-shaped nodes in FIGS. 1 and 2. The gateway nodes are depicted in FIGS. 1 and 2 in accordance with BPMN (business process modeling notation), however may be represented in accordance with any suitable notation. Such gateway nodes typically represent various relationships or behaviors in process graphs 100 and 200. For example, gateway nodes, shown in FIGS. 1 and 2 as diamond-shaped nodes identified with an “X”, may represent exclusive choice relationships. In another example, gateway nodes, shown in FIGS. 1 and 2 as diamond-shaped nodes identified with a “+”, may represent parallel relationships. In a further example, gateways nodes, shown in FIGS. 1 and 2 as diamond-shaped nodes identified with a “ [symbol] ”, may represent looping relationships. Other types of relationships are also contemplated, such as, e.g., sequential relationships.

Often times, process graphs may comprise gateway nodes that do not add meaning but take up a lot of visual space. For example, gateway nodes 102 of process graph 100 of FIG. 1 do not add meaning to process graph 100 and gateway nodes 202 of process graph 200 of FIG. 2 do not add meaning to process graph 200. Gateway nodes 102 and 202 may cause confusion for users viewing process graphs 100 and 200.

In accordance with embodiments described herein, process graphs are visually represented without depicting gateway nodes that do not add meaning to the process graphs. In one embodiment, gateway folding is performed to fold gateway nodes with only a single incoming edge and only a single outgoing edge into their from-node. In another embodiment, paths from parallel gateway nodes that do not include activity nodes are removed and, after removing such paths, if parallel gateway nodes are left with only one path, such parallel gateway nodes are also folded into their from-node. Advantageously, embodiments described herein provide for the display of process graphs in a simplified manner, thereby facilitating user understanding of the process graphs by reducing visual confusion.

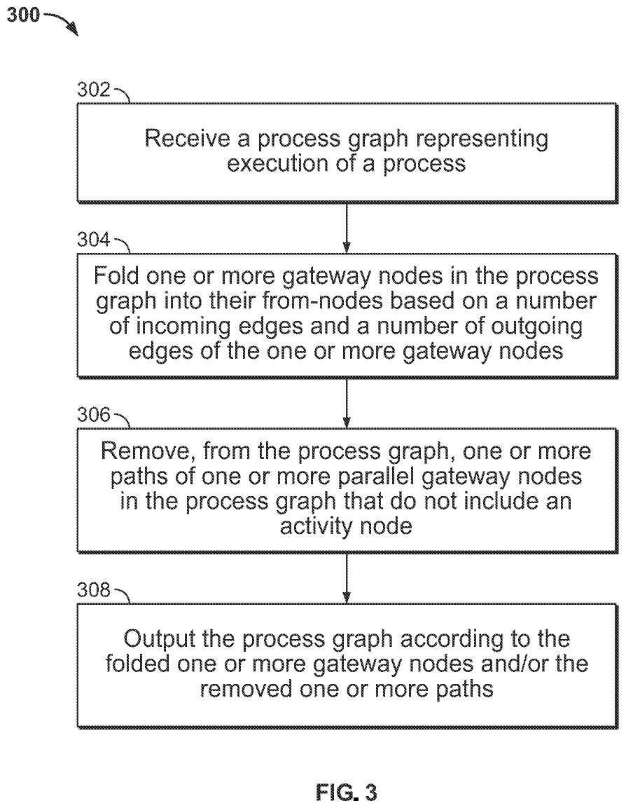

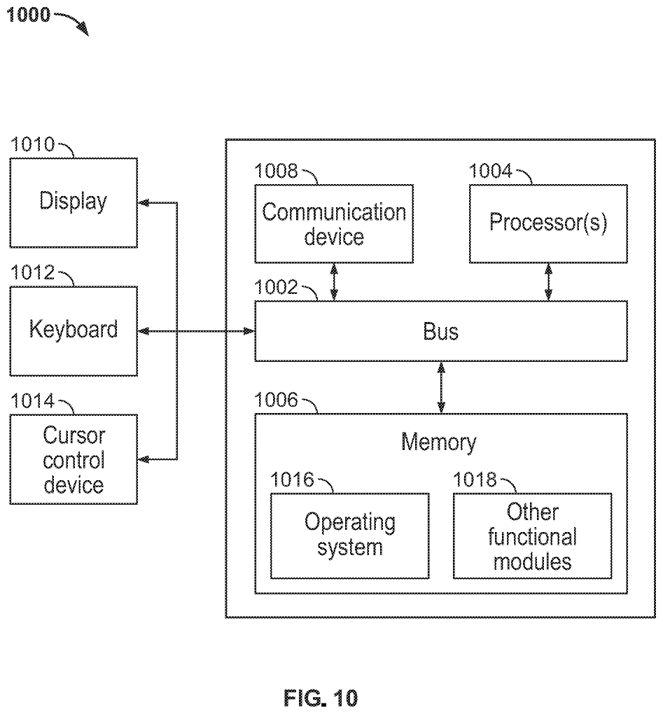

FIG. 3 shows a method 300 for visually representing a process model, in accordance with one or more embodiments. Method 300 will be described with continued reference to process graph 100 of FIG. 1 and process graph 200 of FIG. 2. The steps of method 200 may be performed by any suitable computing device, such as, e.g., computing system 1000 of FIG. 10.

At step 302, a process graph representing execution of a process is received. In one example, the process graph is process graph 100 of FIG. 1 or process graph 200 of FIG. 2. In one embodiment, the process graph represents execution of an RPA process automatically executed by one or more RPA robots. The process graph may be received by loading the process graph from a storage or memory of a computer system or receiving a process graph that has been transmitted from a remote computer system.

At step 304, one or more gateway nodes in the process graph are folded into their from-nodes based on a number of incoming edges and a number of outgoing edges of the one or more gateway nodes. The from-node of a particular gateway node is the closest preceding node of the particular gateway node in the process graph that does not have a single incoming edge and a single outgoing edge. The from-node may be a gateway node, an activity node, or any other suitable node in the process graph. The one or more gateway nodes are folded into their from-nodes by merging the one or more gateway nodes into their from-nodes in the visual representation of the process graph. In one embodiment, the one or more gateway nodes are identified by determining that the one or more gateway nodes have a single incoming edge and a single outgoing edge and, in response, the one or more gateway nodes are folded into their from-nodes.

In one embodiment, the one or more gateway nodes are folded into their from-nodes by traversing the process graph to identify a foldable gateway node having a single incoming edge and a single outgoing edge. The closest preceding non-foldable gateway node a of the foldable gateway node and a next non-foldable gateway node b (i.e., a gateway node that does not have a single incoming edge and a single outgoing edge) of the foldable gateway node are identified. Non-foldable gateway nodes are gateway nodes that do not have a single incoming edge and a single outgoing edge. The plurality of edges between nodes a and b is then replaced with a single folded edge a b in the visual level to simply visualization of the process graph. The sequence of edges is not changed in the data level so that the original process graph is retained. In this manner, the original process graph may be utilized for, e.g., computing analytics and metrics, while simplifying the visual representation of the process graph.

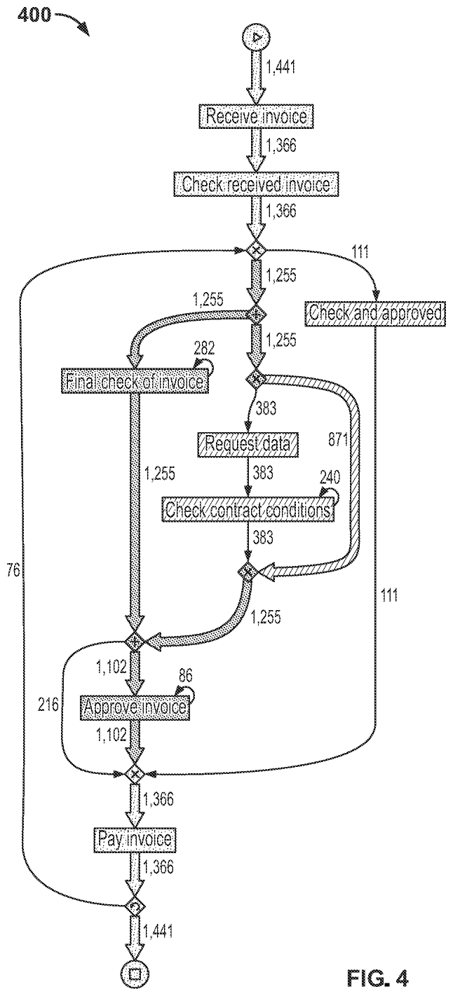

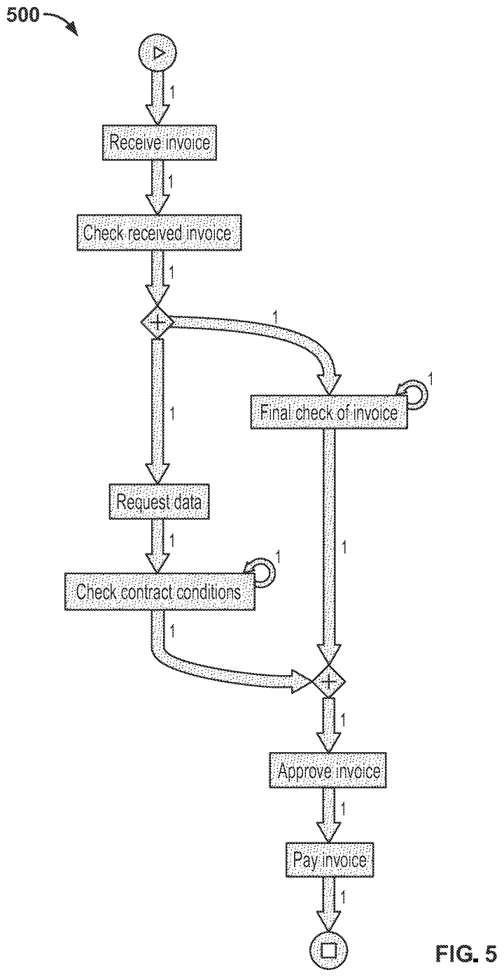

In one example, nodes 102 of process graph 100 of FIG. 1 and nodes 202 of process graph 200 of FIG. 2 have a single incoming edge and a single outgoing edge and are therefore folded into their from-nodes. FIG. 4 shows a visually simplified process graph 400 of process graph 100 of FIG. 1 where nodes 102 are folded into their from-nodes, in accordance with one or more embodiments. FIG. 5 shows a visually simplified process graph 500 of process graph 200 of FIG. 2 where nodes 202 are folded into their from-nodes, in accordance with one or more embodiments.

At step 306 of FIG. 3, one or more paths of one or more parallel gateway nodes in the process graph that do not include an activity node are removed from the process graph. The one or more paths that do not include an activity node may be removed because the one or more paths only occur if the sub-process of the parallel branch is optional. In one embodiment, after removing the one or more paths that do not include an activity node, it is determined whether at least one of the one or more parallel gateway nodes has a single path. In response to determining that at least one of the one or more parallel gateway nodes has a single path, the at least one of the one or more parallel gateway nodes is folded into its from-node.

The one or more paths that do not include an activity node may be removed from parallel gateway nodes in step 306 because paths of parallel gateway nodes that do not include an activity node have no meaning. Paths of gateway nodes of other relationship types, such as, e.g., exclusive choice or loop, that do not include an activity node indicate that the control flow of the process has moved through these paths in at least one iteration and, as such, have more meaning.

At step 308, the process graph according to the folded one or more gateway nodes and/or the removed one or more paths is output. The process graph according to the folded one or more gateway nodes and/or the removed one or more paths is the process graph with the one or more gateway nodes folded and/or the one or more paths removed. In one embodiment, the process graph is output by displaying the process graph to a user on a display device, thereby enabling the presentation of the process graph in a simplified manner to facilitate user understanding of the process graph. In other embodiments, the process graph may be output by, for example, storing the process graph on a memory or storage of a computer system or by transmitting the process graph to a remote computer system.

To enable the computation of metrics, hints, or interaction with (e.g., selection of nodes and/or edges) the process graph, the event log is aligned to the process model by assigning to-event IDs and from-event IDs to all edges between the from-node and the next non-foldable node. For example, a transition from event e1 to event e2 in the event log is mapped to an aligned set of edges in the process graph by assigning, to all edges between the activity nodes of events e1 and e2, event e1 as their from-event ID and event e2 as their to-event ID. To compute metrics, hints, or otherwise interact with a folded edge a→b, the edge is internally represented by the real edge b′→b, where b′ is the preceding node of b. In other words, the folded edge a→b exists only in the visual layout and visualization, and the metrics, hints, or interactions are determined on the real edge b′→b.

In one embodiment, step 304 of method 300 is performed after any filtering (e.g., via a visual complexity slider) since the filtering may make additional gateway nodes meaningless. Since step 304 simplifies paths and does not remove them, the paths for the filtering remain stable. In another embodiment, since paths may be removed at step 306, step 306 is performed prior to any filtering so that the filtering is applied to the paths.

The performance of conformance checking (of an event log against a process model) may results in conformance information for edges. For example, the edges may be identified as being conforming, log only, or model only. In one embodiment, the conformance of the edges is aggregated to conform the folded edges of the process graph to the event log. For example, where one of the folded edges is a log-only edge, the folded edge is also defined to be log-only. In another embodiment, to avoid having to aggregate edge conformance, the folding (at step 304) is performed on gateway nodes with incoming and outgoing edges of the same conformance type.

In one embodiment, the process graph may be visualized via an animation as method 300 is applied. In the animation, the replaced edges will fade out and the folded edges fade in. This may be confusing to the user as it breaks the continuity of the animation. In one embodiment, the set of edges to be replaced may be morphed into their folded edges.

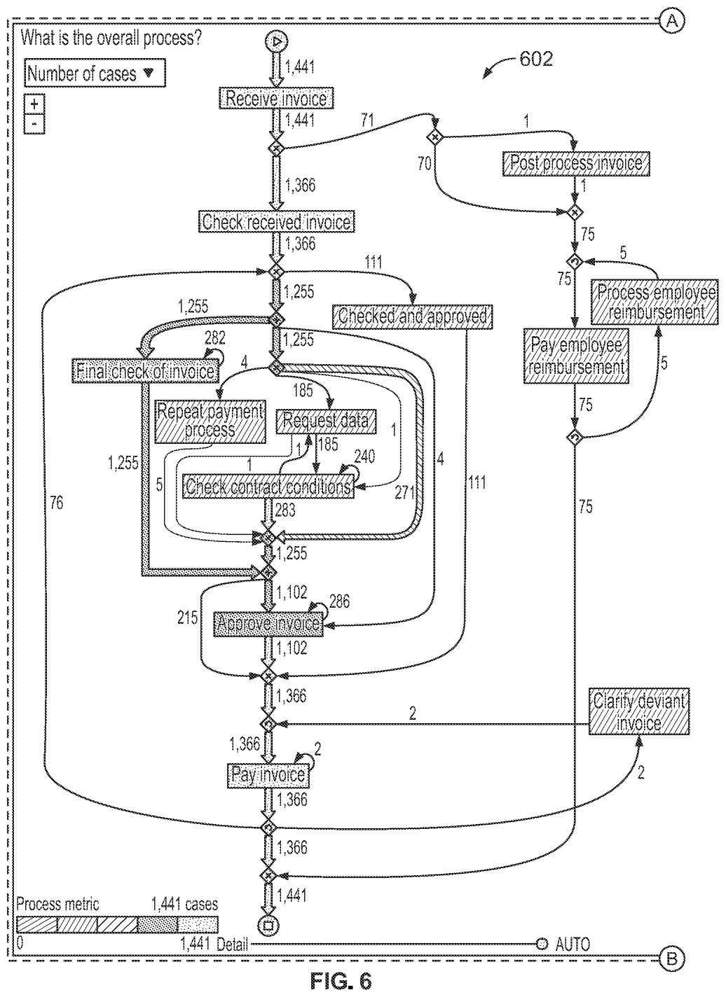

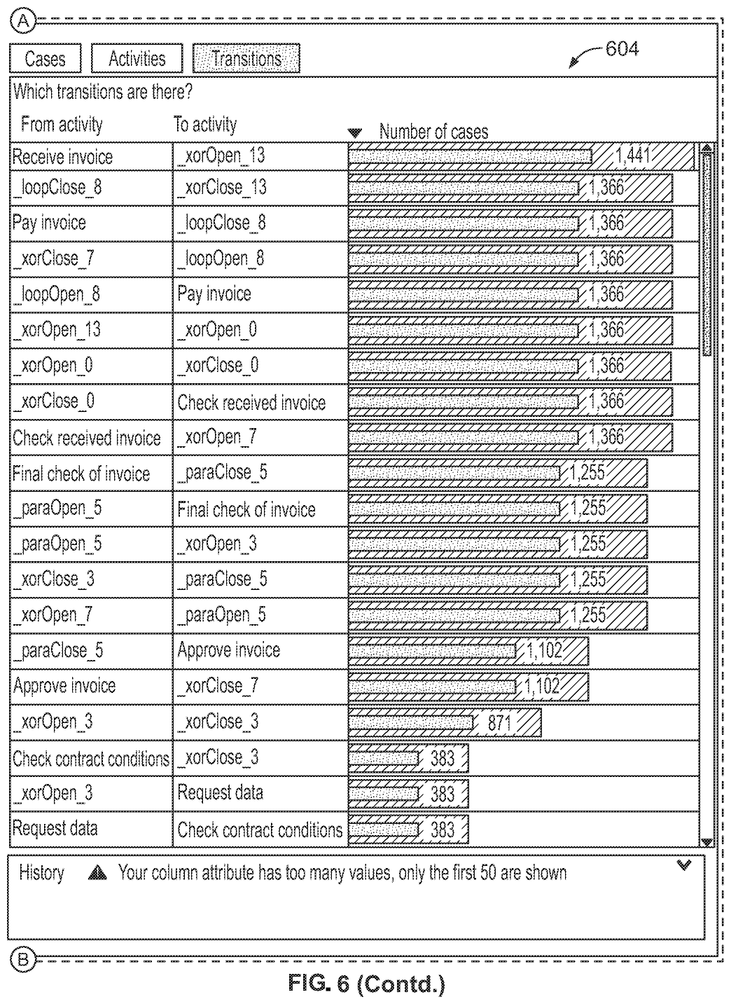

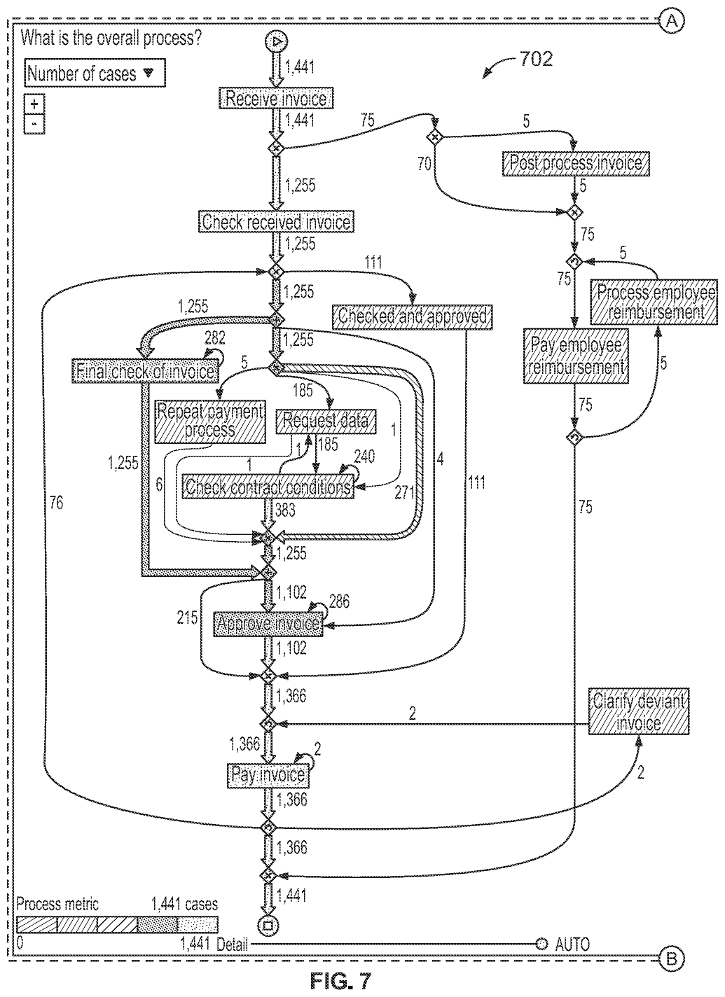

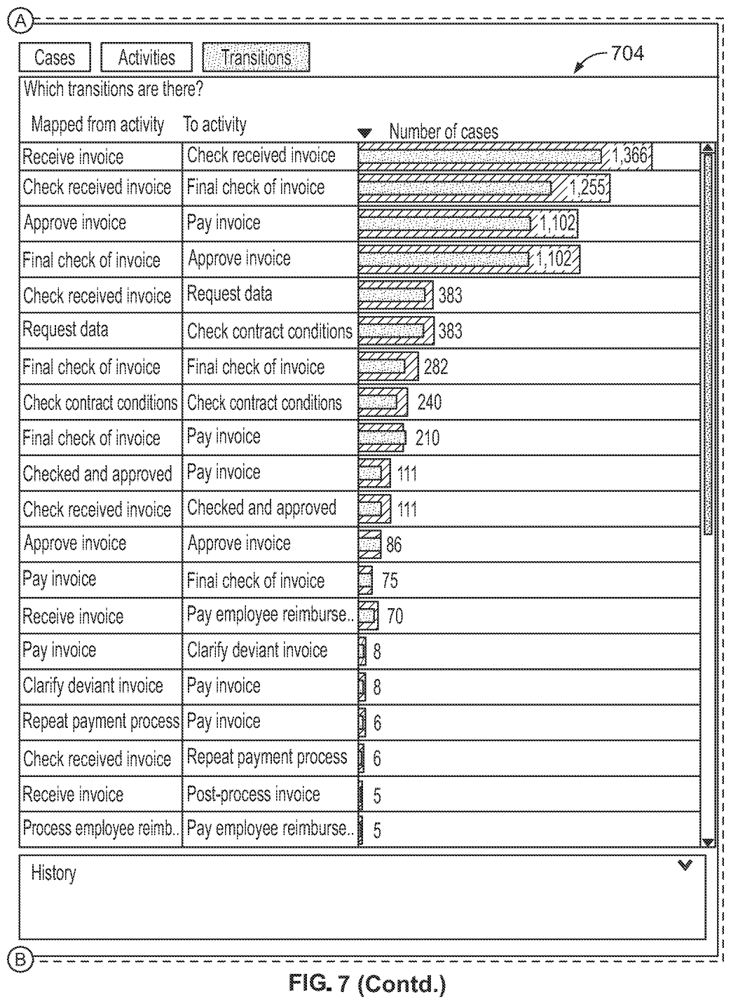

In one embodiment, gateway folding may be applied to simplify the representation of edges or transitions in charts by folding all gateway nodes into their from-activity nodes. For example, FIG. 6 shows a process model 602 with a corresponding edge chart 604 without gateway folding. As shown in FIG. 6, edge chart 604 comprises various edges to and from gateway nodes, which may be visually confusing to users. In accordance with embodiments described herein, such gateway nodes may be folded into their from-activity nodes by merging the gateway nodes into the last preceding activity node. FIG. 7 shows a process model 702 with a corresponding edge chart 704, in accordance with one or more embodiments. Edge chart 704 is edge chart 604 of FIG. 6 with gateway nodes folded into their from-activity nodes.

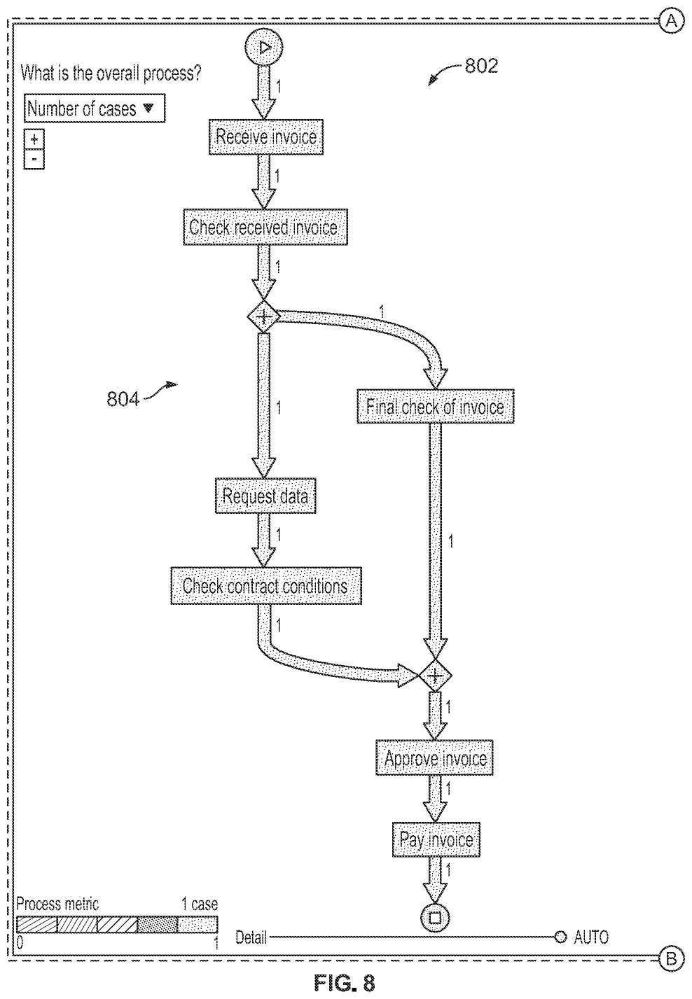

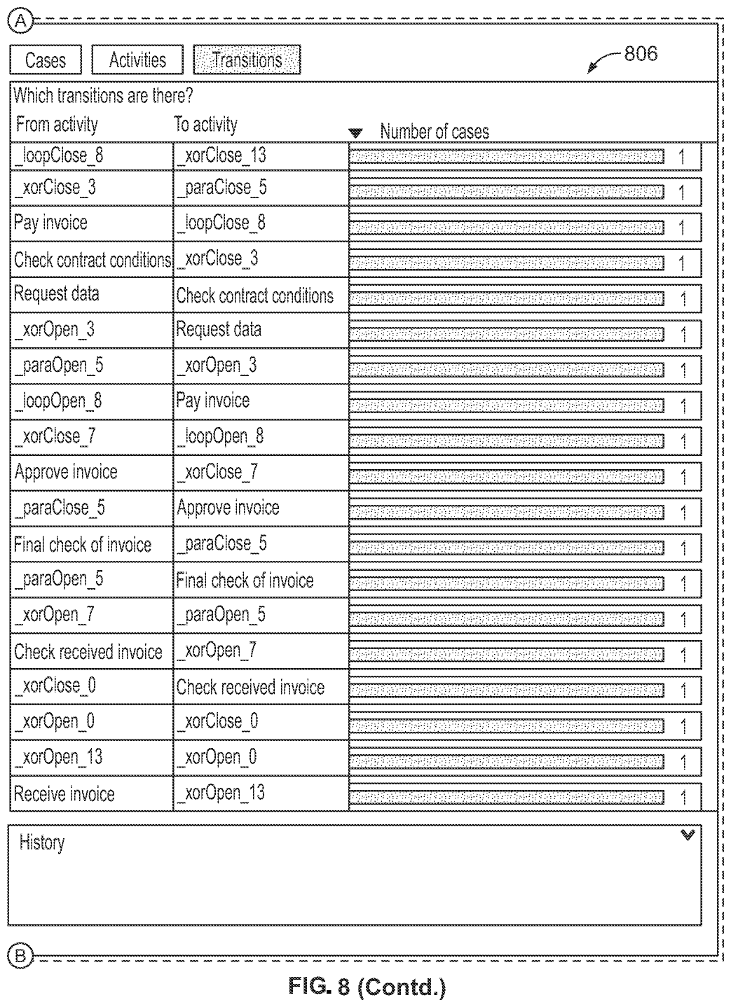

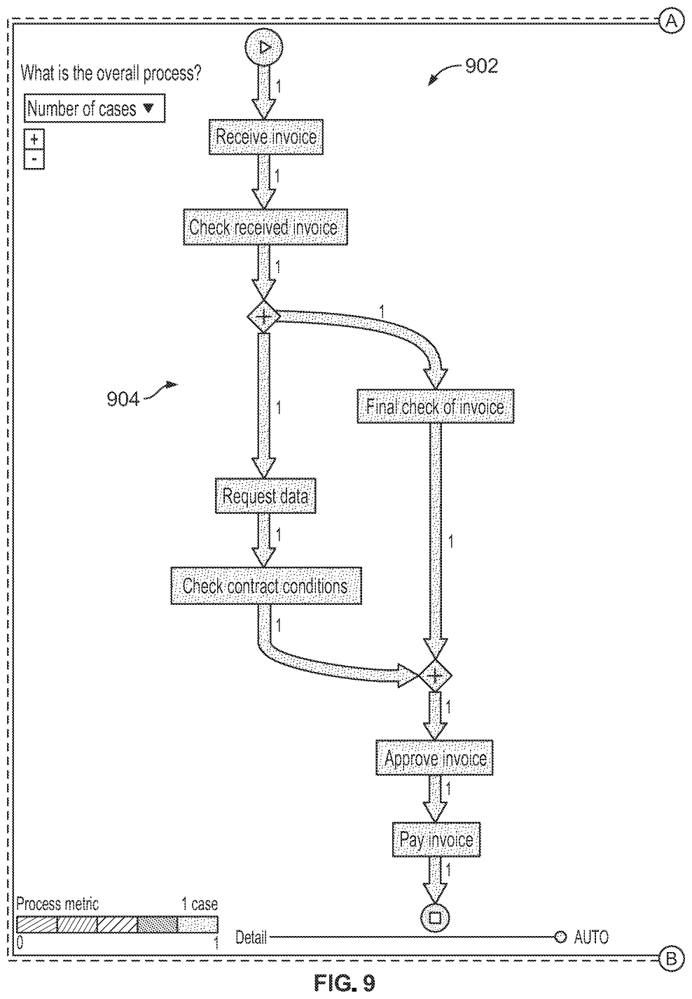

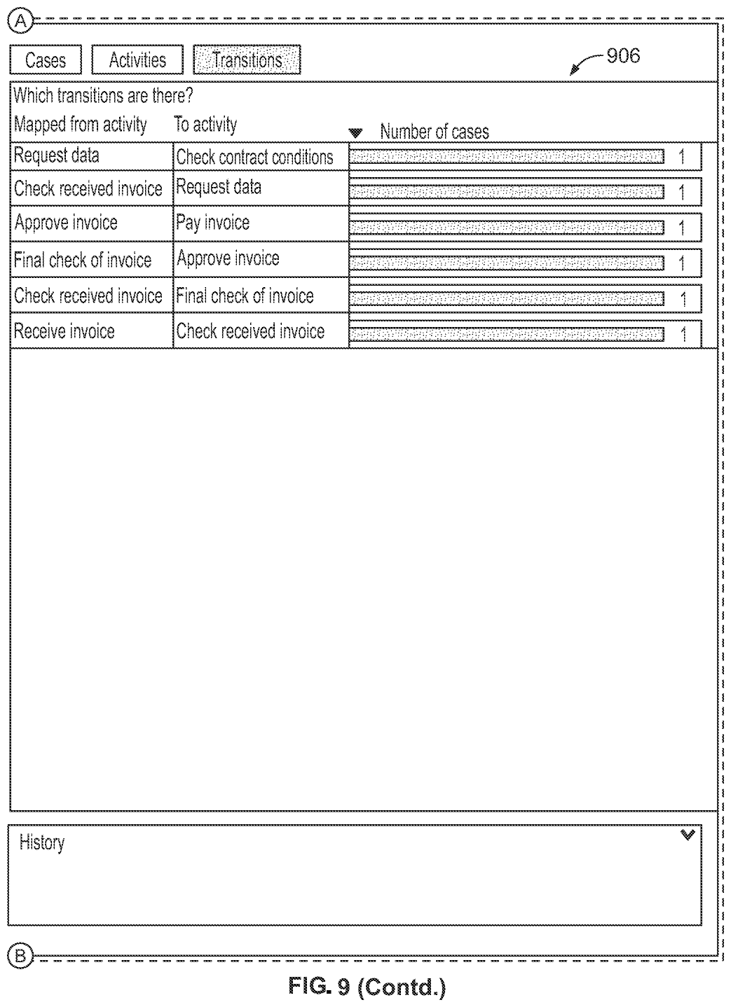

To perform gateway folding on parallel behavior in an edge chart, instead of listing an edge from each branch of the parallel branches to the following activity, only a single folded edge from the last performed activity in the parallel branches to the following activity is identified in the edge chart. For example, FIG. 8 shows a process model 802 with a corresponding edge chart 806 without gateway folding. Process model 802 comprises parallel behavior portion 804. In accordance with embodiments described herein, the gateway nodes are folded by identifying only edge between the last performed activity of the parallel branches and the following activity in the edge chart. FIG. 9 shows a process model 902 with a corresponding edge chart 906, in accordance with one or more embodiments. Edge chart 906 is edge chart 806 of FIG. 8 with gateway nodes folded into their from-activity nodes. In particular, to fold gateway nodes in parallel behavior portion 904 of process graph 902, only the edge between the last performed activity of the parallel branches and the following activity is shown in the edge chart. For example, as shown in FIG. 9, the edge between the activity node corresponding to “final check of invoice” and the activity node corresponding to “approve invoice” is identified in edge chart 906, while the edge between the activity node corresponding to “check contract conditions” and the activity node corresponding to “approve invoice” is not identified in edge chart 906. In one embodiment, while the edge chart shows the edge between the last performed activity in parallel branches and the following activity, an additional chart is created to show the remaining edges in the parallel block. Edge conformance can then be performed based on whether an activity has been skipped or not. The additional chart can be generated during the process alignment or as a post-processing step for each aligned variation.

FIG. 10 is a block diagram illustrating a computing system 1000 configured to execute the methods, workflows, and processes described herein, including FIG. 3, according to an embodiment of the present invention. In some embodiments, computing system 1000 may be one or more of the computing systems depicted and/or described herein. Computing system 1000 includes a bus 1002 or other communication mechanism for communicating information, and processor(s) 1004 coupled to bus 1002 for processing information. Processor(s) 1004 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1004 may also have multiple processing cores, and at least some of the cores may be configured to perform specific functions. Multi-parallel processing may be used in some embodiments.

Computing system 1000 further includes a memory 1006 for storing information and instructions to be executed by processor(s) 1004. Memory 1006 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 1004 and may include volatile media, non-volatile media, or both. The media may also be removable, non-removable, or both.

Additionally, computing system 1000 includes a communication device 1008, such as a transceiver, to provide access to a communications network via a wireless and/or wired connection according to any currently existing or future-implemented communications standard and/or protocol.

Processor(s) 1004 are further coupled via bus 1002 to a display 1010 that is suitable for displaying information to a user. Display 1010 may also be configured as a touch display and/or any suitable haptic I/O (input/output) device.

A keyboard 1012 and a cursor control device 1014, such as a computer mouse, a touchpad, etc., are further coupled to bus 1002 to enable a user to interface with computing system. However, in certain embodiments, a physical keyboard and mouse may not be present, and the user may interact with the device solely through display 1010 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1006 stores software modules that provide functionality when executed by processor(s) 1004. The modules include an operating system 1016 for computing system 1000 and one or more additional functional modules 1018 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
receiving a process graph representing execution of a process;
folding one or more gateway nodes in the process graph into their from-nodes based on a number of incoming edges and a number of outgoing edges of the one or more gateway nodes; and
outputting the process graph according to the folded one or more gateway nodes.

2. The computer-implemented method of claim 1, wherein folding one or more gateway nodes in the process graph into their from-nodes based on a number of incoming edges and a number of outgoing edges of the one or more gateway nodes comprises:
determining that the one or more gateway nodes have a single incoming edge and a single outgoing edge; and
in response determining that the one or more gateway nodes have a single incoming edge and a single outgoing edge, folding the one or more gateway nodes into their from-nodes.

3. The computer-implemented method of claim 1, wherein folding one or more gateway nodes in the process graph into their from-nodes based on a number of incoming edges and a number of outgoing edges of the one or more gateway nodes comprises:
traversing the process graph to identify a foldable gateway node having a single incoming edge and a single outgoing edge;
identifying a closest preceding non-foldable gateway node of the foldable gateway node and a next non-foldable gateway node of the foldable gateway node, wherein the closest preceding non-foldable gateway node and the next non-foldable gateway node do not have a single incoming edge and a single outgoing edge; and
replacing a plurality of edges between the closest preceding non-foldable gateway node and the next non-foldable gateway node with an edge between the closest preceding non-foldable gateway node and the next non-foldable gateway node.

4. The computer-implemented method of claim 1, further comprising:
removing, from the process graph, one or more paths of one or more parallel gateway nodes in the process graph that do not include an activity node.

5. The computer-implemented method of claim 4, further comprising:
folding at least one of the one or more parallel gateway nodes into its from-node in response to determining that the at least one parallel gateway node has a single path.

6. The computer-implemented method of claim 1, further comprising:
folding all gateway nodes in an edge chart associated with the process graph into their from-activity nodes.

7. The computer-implemented method of claim 1, wherein outputting the process graph comprises:
displaying the process graph according to the folded one or more gateway nodes on a display device.

8. The computer-implemented method of claim 1, wherein the process is an RPA (robotic process automation) process.

9. An apparatus comprising:
a memory storing computer instructions; and
at least one processor configured to execute the computer instructions, the computer instructions configured to cause the at least one processor to perform operations of:
receiving a process graph representing execution of a process;
folding one or more gateway nodes in the process graph into their from-nodes based on a number of incoming edges and a number of outgoing edges of the one or more gateway nodes; and
outputting the process graph according to the folded one or more gateway nodes.

10. The apparatus of claim 9, wherein folding one or more gateway nodes in the process graph into their from-nodes based on a number of incoming edges and a number of outgoing edges of the one or more gateway nodes comprises:
determining that the one or more gateway nodes have a single incoming edge and a single outgoing edge; and
in response determining that the one or more gateway nodes have a single incoming edge and a single outgoing edge, folding the one or more gateway nodes into their from-nodes.

11. The apparatus of claim 9, wherein folding one or more gateway nodes in the process graph into their from-nodes based on a number of incoming edges and a number of outgoing edges of the one or more gateway nodes comprises:
traversing the process graph to identify a foldable gateway node having a single incoming edge and a single outgoing edge;
identifying a closest preceding non-foldable gateway node of the foldable gateway node and a next non-foldable gateway node of the foldable gateway node, wherein the closest preceding non-foldable gateway node and the next non-foldable gateway node do not have a single incoming edge and a single outgoing edge; and
replacing a plurality of edges between the closest preceding non-foldable gateway node and the next non-foldable gateway node with an edge between the closest preceding non-foldable gateway node and the next non-foldable gateway node.

12. The apparatus of claim 9, the operations further comprising:
removing, from the process graph, one or more paths of one or more parallel gateway nodes in the process graph that do not include an activity node.

13. The apparatus of claim 12, the operations further comprising:
folding at least one of the one or more parallel gateway nodes into its from-node in response to determining that the at least one parallel gateway node has a single path.

14. The apparatus of claim 9, the operations further comprising:
folding all gateway nodes in an edge chart associated with the process graph into their from-activity nodes.

15. The apparatus of claim 9, wherein outputting the process graph comprises:
displaying the process graph according to the folded one or more gateway nodes on a display device.

16. The apparatus of claim 9, wherein the process is an RPA (robotic process automation) process.

17. A non-transitory computer-readable medium storing computer program instructions, the computer program instructions, when executed on at least one processor, cause the at least one processor to perform operations comprising:
receiving a process graph representing execution of a process;
folding one or more gateway nodes in the process graph into their from-nodes based on a number of incoming edges and a number of outgoing edges of the one or more gateway nodes; and
outputting the process graph according to the folded one or more gateway nodes.

18. The non-transitory computer-readable medium of claim 17, wherein folding one or more gateway nodes in the process graph into their from-nodes based on a number of incoming edges and a number of outgoing edges of the one or more gateway nodes comprises:
determining that the one or more gateway nodes have a single incoming edge and a single outgoing edge; and
in response determining that the one or more gateway nodes have a single incoming edge and a single outgoing edge, folding the one or more gateway nodes into their from-nodes.

19. The non-transitory computer-readable medium of claim 17, wherein folding one or more gateway nodes in the process graph into their from-nodes based on a number of incoming edges and a number of outgoing edges of the one or more gateway nodes comprises:
traversing the process graph to identify a foldable gateway node having a single incoming edge and a single outgoing edge;
identifying a closest preceding non-foldable gateway node of the foldable gateway node and a next non-foldable gateway node of the foldable gateway node, wherein the closest preceding non-foldable gateway node and the next non-foldable gateway node do not have a single incoming edge and a single outgoing edge; and
replacing a plurality of edges between the closest preceding non-foldable gateway node and the next non-foldable gateway node with an edge between the closest preceding non-foldable gateway node and the next non-foldable gateway node.

20. The non-transitory computer-readable medium of claim 17, the operations further comprising:
removing, from the process graph, one or more paths of one or more parallel gateway nodes in the process graph that do not include an activity node.

21. The non-transitory computer-readable medium of claim 20, the operations further comprising:
folding at least one of the one or more parallel gateway nodes into its from-node in response to determining that the at least one parallel gateway node has a single path.

22. The non-transitory computer-readable medium of claim 17, the operations further comprising:
folding all gateway nodes in an edge chart associated with the process graph into their from-activity nodes.

23. The non-transitory computer-readable medium of claim 17, wherein outputting the process graph comprises:
displaying the process graph according to the folded one or more gateway nodes on a display device.

24. The non-transitory computer-readable medium of claim 17, wherein the process is an RPA (robotic process automation) process.
